(19) United States
(12) Patent Application Publication
(10) Pub. No.: US 2022/0393484 A1
(43) Pub. Date: Dec. 8, 2022

(54) BATTERY CELL REBALANCING

(71) Applicant: Hewlett-Packard Development Company, L.P., Spring, TX (US)

(72) Inventors: Fangyong Dai, Spring, TX (US); Ann Alejandro Villegas, Spring, TX (US); Qijun Chen, Spring, TX (US); Gabriel Hector Valencia, Spring, TX (US)

(21) Appl. No.: 17/339,504

(22) Filed: Jun. 4, 2021

(51) Int. Cl. H02J 7/00

(52) U.S. Cl. CPC H02J 7/0014; H02J 7/0047

(57) ABSTRACT

Apparatus, systems, articles of manufacture, and methods to provide battery cell rebalancing are disclosed. An example apparatus includes a first battery cell having a first size. The apparatus further includes a second battery cell having a second size different than the first size. The apparatus further includes a first variable resistor couplable to the first battery cell. The apparatus further includes a second variable resistor couplable to the second battery cell. The apparatus further includes a sensor to determine a first internal resistance of the first battery cell, and a second internal resistance of the second battery cell. The apparatus further includes an integrated circuit to adjust a first resistance of the first variable resistor and a second resistance of the second variable resistor based on the first internal resistance and the second internal resistance.

### BACKGROUND

Computing devices such as laptops, mobile phones, etc. may utilize a battery pack to power the computing devices when not plugged in. The battery pack includes one battery cell or multiples battery cells capable of powering the computing device. In some examples, the battery cell(s) are lithium ion batteries and correspond to a particular size, voltage, capacitance, internal resistance, etc. Such battery cells may be rated to operate under particular conditions (e.g., temperature, current, power, etc.). Operating outside of the ratings may result in damage, premature degradation, etc.

### BRIEF DESCRIPTION OF THE DRAWINGS

FIG. 1A illustrates an example laptop chassis including an example battery pack with symmetrical battery cells.

FIG. 1B illustrates an example laptop chassis including an example battery pack with asymmetrical battery cells.

FIG. 2 illustrates example battery cells that can be balanced, rebalanced, or a combination thereof in conjunction with examples disclosed herein.

FIG. 3 is a block diagram of an example resistance controller integrated circuit of FIG. 2.

FIG. 4 is a flowchart representative of machine readable instructions which may be executed to implement the example resistance controller integrated circuit of FIG. 3.

FIG. 5 is a block diagram of an example processing platform structured to execute the instructions of FIG. 4 to implement the example resistance controller integrated circuit of FIG. 3.

The figures are not to scale. In general, the same reference numbers will be used throughout the drawing(s) and accompanying written description to refer to the same or like parts.

As used herein, connection references (e.g., attached, coupled, connected, and joined) may include intermediate members between the elements referenced by the connection reference, relative movement between those elements, or a combination thereof unless otherwise indicated. As such, connection references do not necessarily infer that two elements are directly connected, in fixed relation, or a combination thereof to each other. As used herein, stating that any part is in “contact” with another part is defined to mean that there is no intermediate part between the two parts.

Unless specifically stated otherwise, descriptors such as “first,” “second,” “third,” etc. are used herein without imputing or otherwise indicating any meaning of priority, physical order, arrangement in a list, ordering in any way, or a combination thereof, but are merely used as labels, arbitrary names, or a combination thereof to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name.

### DETAILED DESCRIPTION

Computing devices (e.g., laptops, cell phones, etc.) may utilize batteries to power such computing devices when not plugged into a power source. Some devices include a battery pack with multiple battery cells to power the computing devices. Known battery packs utilize symmetrical battery cells (e.g., multiple battery cells of the same size corresponding to the same (or very similar) capacity, aging speed, internal resistance, etc.). Because the battery cells are symmetric, the battery cells draw the same or a similar amount of power. For example, the power of a first battery cell corresponds to the voltage of the battery cell and the current drawn out of the battery cell. Because current is a function of voltage and resistance, the power of the battery cells also corresponds to its cell voltage and internal resistance. The power, voltage, current, and resistance are related by:

$$W = V \times I = Vcell \times ( \frac{( Vcell - Vj )}{Rbat} )$$

Where W is power in watts, V is voltage in volts, I is current in amperes, Vcell is the voltage of the battery cell in volts, Vj is the output voltage in volts defined by the load, and Rbat is the internal resistance in ohms of the battery cell.

In symmetrical battery packs, the cell voltage and internal resistance is the same or substantially similar among the battery cells in the battery pack. Thus, the amount of power being drawn across the battery cells is relatively even. In this manner, it is easy to select battery cells that have a sufficient power rating to handle the amount of power drawn by a system. Additionally, because the power being drawn across the battery cells is the same or similar, the battery cells tend to degrade in a similar manner, thereby avoiding misbalances between aging battery cells.

However, known battery packs or the use or the same size battery cell may correspond to inefficient use of the space available in computing devices, because having similar batteries corresponds to having similarly size batteries, which limits how the battery pack can fit in the computing device. In this manner, symmetrical battery packs inefficiently use the open space in a computing device.

An asymmetrical battery system may be used to increase battery capacity in a computing device. An asymmetrical battery system uses different sized cells selected to occupy a maximum amount of available space in a computing device. However, because of the differences in cell capacity, cell aging speed, cell internal resistance, etc., the output power drawn by the individual battery cells is different, thereby causing cells with less internal resistance to supply higher power. Unbalanced cells correspond to a shorter battery cycle life, may result in damage to the battery cells, or a combination thereof. For example, a battery cell with a small internal resistance draws more current from a load leading to more power being drawn from the battery cell. In such an example, if the battery cell is drawing 7 Watts of power and is rated for 4 Watts of power, the battery cell may deteriorate more quickly, may become damaged, may become hot enough to damage other components of the computing device, or a combination thereof.

Examples disclosed herein balance the power distribution of the individual battery cells, rebalance the power distribution of the individual battery cells, or a combination thereof to ensure the discharging power of the individual cells is proportional to its respective capacity using logic-controlled variable resistors, thereby ensuring that the power drawn by the individual cells is matched to its respective power rating. Because the power distribution is a function of the internal resistance of the cell, examples disclosed herein include a variable resistor to the output of the individual cells to control the power distribution to the cells. In this manner, the variable resistance of the individual cells can be tuned to match the desired power distribution for the cells. Additionally, or alternatively, the variable resistances can be tuned for any desired result. For example, variable resistance can be tuned so charges on the battery cells run out at the same time, so the battery cells are fully charged at the same time, etc. Additionally, because the internal resistance of the individual cells changes with time, examples disclosed herein can rebalance the battery cells (e.g., for the power distribution, charging time, discharging time, etc.) by periodically adjusting the resistance of the variable resistors based on the internal resistance and voltage of the individual cells.

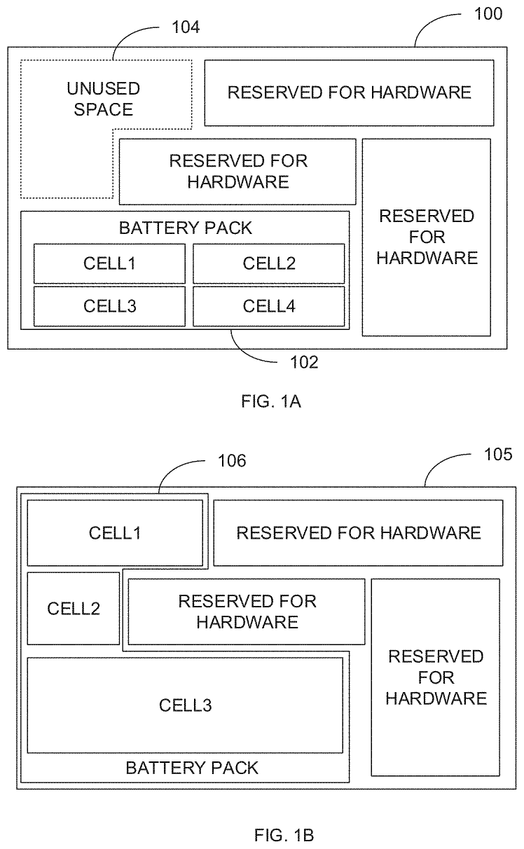

FIGS. 1A-1B illustrate the geometric advantages of including an asymmetrical battery pack, asymmetrical batteries, or a combination thereof in example laptop chassis 100, 105. The example laptop chassis 100 includes an example symmetrical battery pack and example unused space 104. The example laptop chassis 105 includes an example asymmetrical battery pack 106. A symmetrical battery cells are battery cells that have different geometric sizes, different voltages, different power ratings, different internal resistances, different capacitances, etc.

As illustrated in FIG. 1A, the use of the example symmetrical battery pack 102 with four cells of the same or substantially the same size. Accordingly, the location of the battery pack 102 leaves the example unused space 104 in the example chassis 100. To provide more battery capacity, the example chassis 105 of FIG. 1B includes the example asymmetrical battery pack 106 with three asymmetrical battery cells corresponding to different sizes. Because the battery pack 106 includes different sized battery cells (e.g., different dimensions corresponding to different capacity, voltage, internal resistance, charging speed, charging time, discharging speed, discharging time, etc.), the battery cell 106 of FIG. 1B is able to utilize the unused space 104 of FIG. 1A, thereby providing more capacity than the battery pack 102 of FIG. 1A.

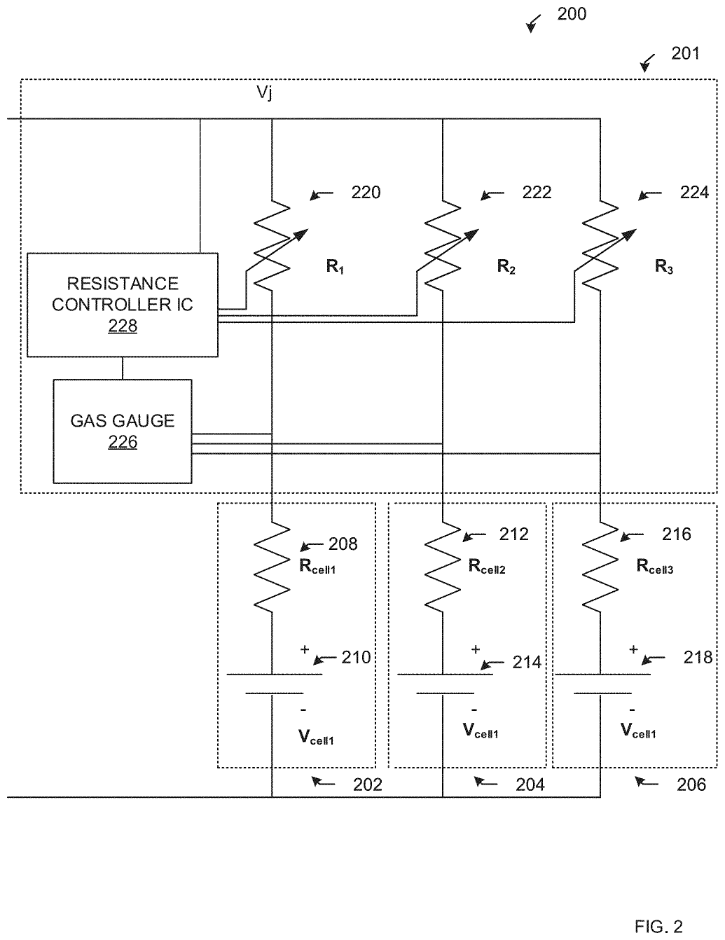

FIG. 2 illustrates an example circuit 200 including an example balance circuit 201 to balance or rebalance the example battery cells 202, 204, 206. The example battery cells 202, 204, 206 include example internal resistances 208, 212, 216 and example voltage sources 210, 214, 218. The balance circuit 201 includes example variable resistors 220, 222, 224, an example gas gauge 226, and an example resistance controller integrated circuit (IC) 228. Although the example circuit 200 of FIG. 2 includes three battery cells with three variable resistors, there may be any number of battery cells and any number of variable resistors.

The example battery cells 202, 204, 206 of FIG. 2 provide power to a load (e.g., components of a computing device). The individual battery cell 202, 204, 206 are coupled in parallel and correspond to a cell voltage 210, 214, 218 and an internal resistance 208, 212, 216. In some examples, two of the battery cells 202, 204, 206 or more of the battery cells 202, 204, 206 may be coupled in series. In the example of FIG. 2, the cells 202, 204, 206 are asymmetrical (e.g., the voltages 210, 214, 218, capacitances, temperatures, internal resistances 208, 212, 216, etc. vary across the battery cells 202, 204, 206). However, in some examples, the cells 202, 204, 206 may be symmetrical. In this manner, examples disclosed herein can balance and rebalance the cells 202, 204, 206 due to manufacturing variance (e.g., because the individual cell 202, 204, 206 may have slightly different (e.g., ±5%) internal resistance, may have slightly different capacitance, may degrade differently over time, etc.). The example battery cells 202, 204, 206 are coupled to the corresponding example variable resistors 220, 222, 224.

The example variable resistors 220, 222, 224 of FIG. 2 are resistors whose resistance is based on a control signal from the example resistance controller IC 228. Accordingly, the resistance controller IC 228 may output different signals to the different resistors 220, 222, 224 so that the respective resistors 220, 222, 224 correspond to different resistance values. In this manner, the example resistance controller IC 228 can control the current, power, or combination thereof, being drawn by the respective battery cells 202, 204, 206 when discharging based on the selected resistance for the respective variable resistors 220, 222, 224. The example resistance controller IC 228 also can control the current, power, or combination thereof being used to charge the respective battery cells 202, 204, 206 during charging of the battery cells 202, 204, 206 based on the selected resistance for the respective variable resistors 220, 222, 224.

The example gas gauge 226 of FIG. 2 is coupled to the outputs of the respective battery cells 202, 204, 206. The example gas gauge 226 can be a type of sensor that measures or infers the voltages 210, 214, 218 of the battery cells 202, 204, 206; the currents drawn out of or into the battery cells 202, 204, 206; the amount of capacitance of the example battery cells 202, 204, 206; charge left in the example battery cells 202, 204, 206; the temperature(s) of the example battery cells 202, 204, 206; the power drawn by the example battery cells 202, 204, 206; the example internal resistances 208, 212, 216 of the battery cells 202, 204, 206; or combination thereof. In some examples, the gas gauge 226 uses the Vj output voltage to determine the internal resistances 208, 212, 216 based on sensed currents pulled from the example battery cells 202, 204, 206. In such examples, the gas gauge 226 may sense the voltage Vj or may obtain the voltage Vj from the example resistance controller IC 228. The example gas gauge 226 transmits the sensed or determined voltages 210, 214, 218 and the example internal resistances 208, 212, 216 to the example resistance controller IC 228. Additionally or alternatively, the example gas gauge 226 may transmit any sensed or determined data to the example resistance controller IC 228. In some examples, the gas gauge 226 may transmit an indication or trigger that identifies that the battery cells 202, 204, 206 are fully charged. In some examples, the gas gauge 226 may compare a desired or calculated power distribution to an actual (e.g., measured) power distribution of the example battery cells 202, 204, 206. If the actual power distribution differs from the desired power distribution by more than a threshold amount, the gas gauge 226 may trigger a rebalance of the battery cells 202, 204, 206 by sending instructions (e.g., an interrupt) to the example resistance controller IC 228.

The example resistance controller IC 228 obtains the voltages 210, 214, 218 and the example resistance(s) 208, 212, 216 of the example battery cells 202, 204, 206. In some examples, the resistance controller IC 228 senses the output voltage Vj and transmits the Vj to the example gas gauge 226 so that the gas gauge 226 can determine the resistances 208, 212, 216. The example resistance controller IC 228 determines a desired resistance to apply for the example variable resistors 220, 222, 224 based on the obtained voltages, internal resistance, and a desired characteristic. For example, if the desired characteristic corresponds to ensuring that the battery cells do not draw more power than the battery cells are rated for, the example resistance controller IC 228 calculates an amount of resistance for the individual variable resistors 220, 222, 224 to distribute power across the battery cells 202, 204, 206 so that none of the battery cells 202, 204, 206 draws more power than the battery cells can handle. For example, if the first cell 202 is rated to operate at or below 7.35 Watts-hours (Wh), the second cell 204 is rated to operate at or below 3.52 Wh, the third cell 204 is rated to operate at or below 9.41 Wh, and the load is drawing a total of 20.28 Wh from the battery cells 202, 204, 206, the example resistance controller IC 228 determines the resistance for the variable resistors 220, 222, 224 (e.g., R1, R2, R3) to match the desired power distribution. For example, the example resistance controller IC 228 selects respective resistances R1, R2, R3 for the respective variable resistors 220, 222, 224 that satisfy the ratio:

$$Vcell 1 ( \frac{( Vcell 1 - Vj )}{( Rcell 1 + R 1 )} ) : Vcell 2 ( \frac{( Vcell 2 - Vj )}{( Rcell 2 + R 2 )} ) : Vcell 3 ( \frac{( Vcell 3 - Vj )}{( Rcell 3 + R 3 )} ) = 7.35 : 3.52 : 9.41$$

However, when the battery cells 202, 204, 206 are fully charged (e.g., which is tracked by the gas gauge 226), the charge density of the battery cells are the same. Thus, when the battery cells 202, 204, 206 are fully charged, the cell voltages of the battery cells 202, 204, 206 are the same. Accordingly, the above ratio can be simplified to remove the voltages and the example resistance controller IC 228 can select the respective resistances R1, R2, R3 for the respective variable resistors 220, 222, 224 that satisfy the ratio:

$$( \frac{1}{( Rcell 1 + R 1 )} ) : ( \frac{1}{( Rcell 2 + R 2 )} ) : ( \frac{1}{( Rcell 3 + R 3 )} ) = 7.35 : 3.52 : 9.41$$

However, the resistance controller IC 228 can control the variable resistors for any purpose. For example, if different cell charge levels are detected during a charging cycles, the example resistance controller IC 228 may tune the ratio so that the cells with the lower charge levels receive a higher charging power until all cells are fully charged (e.g., by decreasing the variable resistance). After the resistance controller IC 228 balances the cells by outputting the control signals to the example variable resistors 220, 222, 224 to operate at the determined resistance, the resistance controller IC 228 may rebalance the cells by re-executing the balancing protocol periodically, aperiodically, or based on a trigger. The resistance controller IC 228 may adjust the frequency of rebalancing based on how quickly the characteristics (e.g., voltage, current, internal resistance, etc.) change for one of the battery cells 202, 204, 206 or for multiple ones of the battery cells 202, 204, 206.

In some examples, the resistance controller IC 228 may determine (e.g., sense or infer) a voltage across the respective variable resistors 220, 222, 224, a current drawn from the example batteries 202, 204, 206, a power drawn from the example battery cells 202, 204, 206, etc. In such examples, the information determined by the resistance controller IC 228 can be compared with the information determined by the gas gauge 226 to identify a misbalance and trigger a rebalancing of the battery cells 202, 204, 206, etc. In some examples, the resistance controller IC 228 may perform an aspect or multiple aspects of the gas gauge 226.

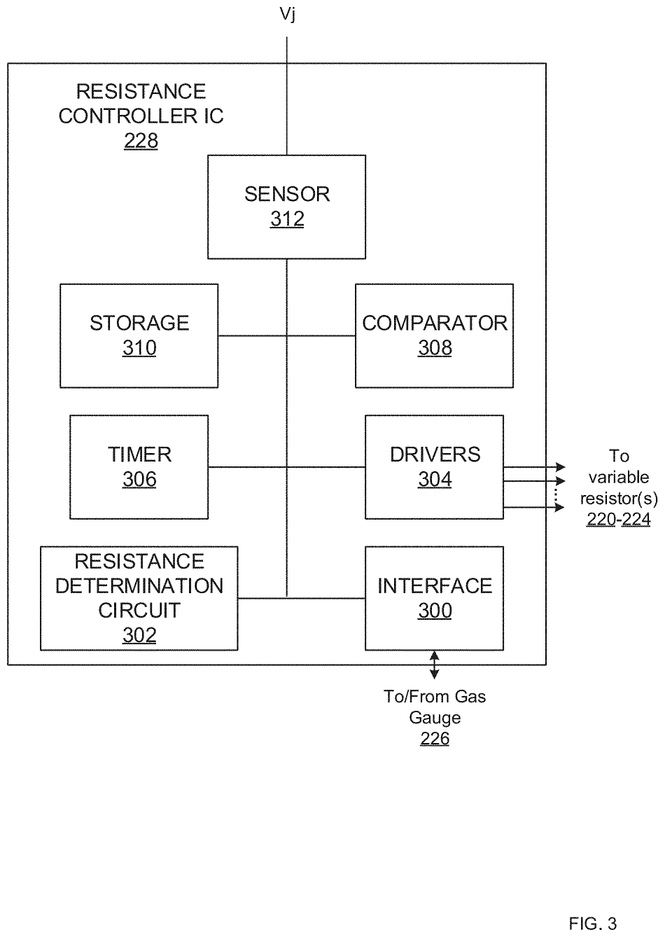

FIG. 3 is a block diagram of an example implementation of the resistance controller IC 228 of FIG. 2. The example resistance controller IC 228 includes an example interface 300, an example resistance determination circuit 302, example drivers 304, an example timer 306, an example comparator 308, example storage 310, and an example sensor 312.

The example interface 300 of FIG. 3 obtains information corresponding to the example battery cells 202, 204, 206 from the example gas gauge 226. In some examples, the interface 300 requests the information from the gas gauge 226 (e.g., for an initial balance or for a subsequent rebalance). In such example the interface 300 transmit the request for information based on a trigger from the timer 306 (e.g., after a threshold amount of time). In some examples, the interface 300 receives rebalancing triggers from the example gas gauge 226. In some examples, the interface 300 transmits sensed information, determined information, or combination thereof to the example gas gauge 226. In this manner, the gas gauge 226 can identify whether the operation of the battery cells 202, 204, 206 align with a desired power distribution. If the example resistance controller IC 228 senses information (e.g., power, current, or combination thereof from the battery cells 202, 204, 206, voltage drops across the variable resistors 220, 222, 224, etc.), infers information, or combination thereof, the interface 300 can transmit such information to the gas gauge 226 to further monitor the power distribution. For example, the interface 300 may transmit sensed output voltage Vj from the example sensor 312 to the example gas gauge 226 so that the gas gauge 226 can use the Vj to determine the internal resistances 208, 212, 216.

The example resistance determination circuit 302 of FIG. 3 determines the resistance to be applied by ones of the variable resistors 220, 222, 224 to achieve a desired power distribution based on the internal resistances of the example battery cells 202, 204, 206, voltages of the example battery cells 202, 204, 206, or combination thereof. For example, to ensure that the power being drawn from ones of the battery cells 202, 204, 206 does not exceed the ratings of the respective battery cells 202, 204, 206, the example resistance determination circuit 302 determines the alternative or additional resistance (R1, R2, R3) that is to be added (e.g., using the example variable resistors 220, 222, 224) using a power distribution ratio where the other variables are known (e.g., from the gas gauge 226) or given/preset (e.g., the power being pulled across all battery cells 202, 204, 206). For example, the resistance determination circuit 302 determines R1, R2, R3 to satisfy the ratio:

$$Vcell 1 ( \frac{( Vcell 1 - Vj )}{( Rcell 1 + R 1 )} ) : Vcell 2 ( \frac{( Vcell 2 - Vj )}{( Rcell 2 + R 2 )} ) : Vcell 3 ( \frac{( Vcell 3 - Vj )}{( Rcell 3 + R 3 )} ) = Wmax\_cell1 : Wmax\_cell2 : Wmax\_cell3$$

If the balance or rebalancing protocol is performed when the battery cells 202, 204, 204 are fully charged, the resistance determination circuit 302 determines R1, R2, R3 to satisfy the ratio:

$$( \frac{1}{( Rcell 1 + R 1 )} ) : ( \frac{1}{( Rcell 2 + R 2 )} ) : ( \frac{1}{( Rcell 3 + R 3 )} ) = Wmax\_cell1 : Wmax\_cell2 : Wmax\_cell3$$

In some examples, there may be multiple solutions for resistances R1, R2, R3 that satisfy the desired power distribution. In such examples, the resistance determination circuit 302 may select the resistances R1, R2, R3 that result in a lower resistance. Additionally or alternatively, the resistance determination circuit 302 may consider secondary objectives/outcomes (e.g., discharge time, charge time, temperature, etc.) when selecting from one of the solutions. The example resistance determination circuit 302 instructs the example drivers 304 to output voltages corresponding to the resistances to cause the resistors 220, 222, 224 to operate at the determined resistance values.

In some examples, the resistance determination circuit 302 includes an artificial intelligence (AI) model (e.g., a learning model, a deep learning model, a neural network, etc.). In such examples, the AI model is trained based on training data. The training data may be battery cell voltage(s), battery cell resistance(s), battery cell capacitance(s), etc. across different numbers of battery cells that is/are tagged with a desired variable resistance. The trained data adjust weights or neurons in the AI-based model to train the AI model to select resistance values based on the input data. In some examples, a portion of the training data is used to train the AI model and a second portion of the training data is used to test the initially trained model to determine if the weights are to be tuned further. For example, if the error of the model is above a threshold, the weights can be further tuned. In this manner, the AI model is trained to develop resistance values to balance battery cells based on different situations. The AI model based model may be trained at a different location and deployed (e.g., initially when manufactured or based on an update to the software) to operate in the example resistance determination circuit 302. Once deployed, the AI model obtains various input data (e.g., a number of cell voltage(s), cell internal resistance(s), etc. corresponding to a number of cells in the battery pack) and generates resistance values to apply to the example variable resistors 220, 222, 224 (e.g., a first resistance for the first resistor 220, a second resistance for the second resistor 222, and a third resistance for the third resistor 224) to distribute power according to the power ratings of the individual battery cells 202, 204, 206.

Although the example resistance determination circuit 302 is described in conjunction with power distribution, power ratings, or combination thereof, the resistance determination circuit 302 may select resistance values based on a desired output, an objective (e.g., to ensure that the battery cells are depleted at the same time, rate, or combination thereof to ensure that the battery cells are charged at the same time, rate, or combination thereof to speed up or slow down depletion or charging of one or multiple ones of the battery cells, to reduce the temperature produced by one battery cell or multiple battery cells, etc.), or combination thereof.

The example drivers 304 of FIG. 3 output signals (e.g., voltages) to the example variable resistor(s) 220, 222, 224 corresponding to the selected resistance values from the example resistance determination circuit 302. The example variable resistor(s) 220, 222, 224 change resistance based on the voltage applied to the respective variable resistor 220, 222, 224. Accordingly, the example drivers 304 output (a) a first voltage to adjust the first variable resistor 220 based on the determined resistance form the resistance determination circuit 302, (b) a second voltage to adjust the second variable resistor 222 based on the determined resistance form the resistance determination circuit 302, and (c) a third voltage to adjust the third variable resistor 224 based on the determined resistance form the resistance determination circuit 302. In some examples, the drivers 304 may be one driver to output the different signals to the different variable resistors 220-224.

The example timer 306 of FIG. 3 tracks a duration of time between rebalancing events. The timer 306 initiates or resets when or after a balancing or rebalancing event occurs and triggers the interface 300 to pull updated information corresponding to the battery cells 202, 204, 206 from the example gas gauge 226 after a threshold amount of time or after an event (e.g., after X number of charging event, after X number of discharging events, based on user interaction, etc.). The threshold amount of time may be set to an initial value or may be adjusted based on an amount of change in the one characteristic or multiple characteristics (e.g., internal resistance 208, 212, 216, example voltage 210, 214, 218, cell capacity, temperature, etc.) of one of the battery cells 202, 204, 206 or multiple ones of the battery cells 202, 204, 206. For example, the rebalancing frequency may increase as the amount of change of one of the battery cells 202, 204, 206 or multiple ones of the battery cells 202, 204, 206 increases.

The example comparator 308 of FIG. 3 compares the obtained battery cell information from the gas gauge 226 to previous or other battery cell information stored in the example storage 310. The example comparator 308 compares the obtained battery information to previous or other battery cell information from one battery cell or from multiple battery cells. The comparator 308 compares the battery information based on a threshold or multiple thresholds. For example, the comparator 308 determines if one of the battery cells 202, 204, 206 or multiple ones of the battery cells 202, 204, 206 have changed by the threshold amount or by multiple threshold amounts. In this manner, if the amount of change is small, the rebalancing frequency can be decreased to conserve resources. However, if the amount of change is large, the comparator 308 increases the rebalancing frequency to ensure that the battery cells 202, 204, 206 are properly balanced to avoid damage to the battery cells. In some examples, there may be multiple thresholds corresponding to different rebalancing frequencies. For example, if the amount of change is above a first threshold, the comparator 308 is to adjust the polling frequency by a first amount. Also, if the amount of change is above a second threshold, the comparator 308 is to adjust the polling frequency by a second amount.

The example sensor 312 of FIG. 3 senses the output voltage Vj. The example sensor 312 transmits the sensed voltage to the example gas gauge 226. In this manner, the example gas gauge 226 can use the output voltage to determine the internal resistances 208, 212, 216 of the battery cells 202, 204, 206.

While an example manner of implementing the example resistance controller IC 228 of FIG. 2 is illustrated in FIG. 3, one element or multiple elements, processes, devices, etc. illustrated in FIG. 3 may be combined, divided, re-arranged, omitted, eliminated, implemented in any other way, or combination thereof. Further, the example interface 300, the example resistance determination circuit 302, the example drivers 304, the example timer 306, the example comparator 308, the example storage 310, or combination thereof, or, more generally, the example resistance controller IC 228 of FIG. 3 may be implemented by hardware, software, firmware, or any combination of hardware, software, or firmware. Thus, for example, any of the example interface 300, the example resistance determination circuit 302, the example drivers 304, the example timer 306, the example comparator 308, the example storage 310, or combination thereof, or, more generally, the example resistance controller IC 228 of FIG. 3 could be implemented by one or multiple ones of analog or digital circuit(s), logic circuits, programmable processor(s), programmable controller(s), graphics processing unit(s) (GPU(s)), digital signal processor(s) (DSP(s)), application specific integrated circuit(s) (ASIC(s)), programmable logic device(s) (PLD(s)), field programmable logic device(s) (FPLD(s)), or combination thereof. When reading any of the apparatus or system claims of this patent to cover a purely software, a firmware implementation, or combination thereof, the example interface 300, the example resistance determination circuit 302, the example drivers 304, the example timer 306, the example comparator 308, the example storage 310, or a combination therefor, or, more generally, the example resistance controller IC 228 of FIG. 3 is/are hereby expressly defined to include a non-transitory computer readable storage device or storage disk such as a memory, a digital versatile disk (DVD), a compact disk (CD), a Blu-ray disk, etc. including the software, the firmware, or combination thereof. Software and firmware include machine readable instructions. Further still, the example resistance controller IC 228 of FIG. 3 may include element(s), process(es), device(s), or combination thereof in addition to, or instead of, those illustrated in FIG. 3, and may include more than one of any or all of the illustrated elements, processes, and devices. As used herein, the phrase “in communication,” including variations thereof, encompasses direct communication, indirect communication, or combination thereof through one or multiple ones of intermediary components, and does not require direct physical (e.g., wired) communication constant communication, of combination thereof, but rather additionally includes selective communication at periodic intervals, scheduled intervals, aperiodic intervals, one-time events, or combination thereof.

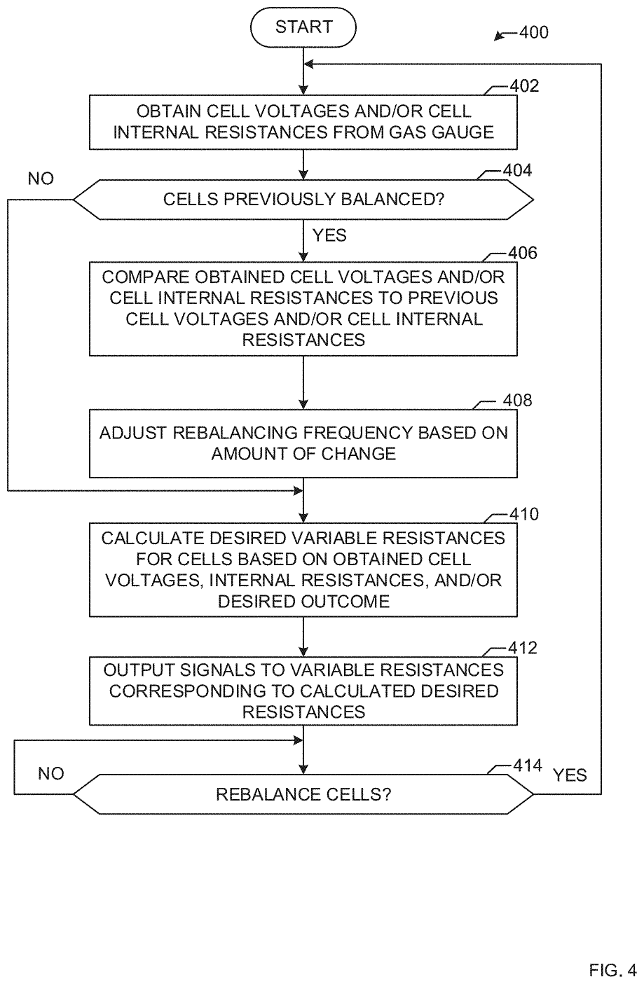

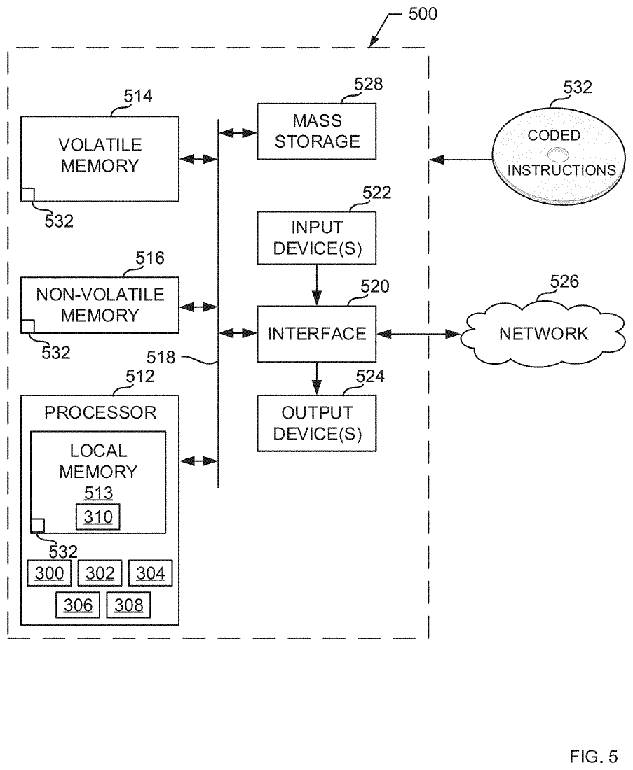

A flowchart representative of example hardware logic, machine readable instructions, hardware implemented state machines, or any combination thereof for implementing the example resistance controller IC 228 of FIG. 3 is shown in FIG. 4. The machine readable instructions may be one or multiple ones of executable programs or portion(s) of an executable program for execution by a computer processor, processor circuitry, or combination thereof, such as the processor 512 shown in the example processor platform 500 of FIG. 5. The program may be embodied in software stored on a non-transitory computer readable storage medium such as a CD-ROM, a floppy disk, a hard drive, a DVD, a Blu-ray disk, or a memory associated with the processor 512, but the entire program or parts thereof could alternatively be executed by a device other than the processor 512 or may be embodied in firmware or dedicated hardware. Further, although the example program is described with reference to the flowchart illustrated in FIG. 5, many other methods of implementing the example resistance controller IC 228 of FIG. 3 may alternatively be used. For example, the order of execution of the blocks may be changed. Additionally or alternatively, some of the blocks described may be changed, eliminated, or combined. Additionally or alternatively, any or all of the blocks may be implemented by hardware circuit(s) (e.g., discrete circuitry, integrated analog circuitry, digital circuitry, an FPGA, an ASIC, a comparator, an operational-amplifier (op-amp), a logic circuit, etc.) structured to perform the corresponding operation without executing software or firmware. The processor circuitry may be distributed in different network locations, local to device(s) (e.g., a multi-core processor in a single machine, multiple processors distributed across a server rack, etc.), or a combination thereof.

The machine readable instructions described herein may be stored in a format or in multiple formats including a compressed format, an encrypted format, a fragmented format, a compiled format, an executable format, a packaged format, etc. Machine readable instructions as described herein may be stored as data or a data structure (e.g., portions of instructions, code, representations of code, etc.) that may be utilized to create, manufacture, produce, etc. machine executable instructions. For example, the machine readable instructions may be fragmented and stored on storage device(s) computing device(s) (e.g., server(s)), or combination thereof located at the same or different locations of a network or collection of networks (e.g., in the cloud, in edge devices, etc.). The machine readable instructions may utilize installation, modification, adaptation, updating, combining, supplementing, configuring, decryption, decompression, unpacking, distribution, reassignment, compilation, etc. in order to make them directly readable, interpretable, executable, or combination thereof by a computing device, other machine, or combination thereof. For example, the machine readable instructions may be stored in multiple parts, which are individually compressed, encrypted, and stored on separate computing devices, wherein the parts when decrypted, decompressed, and combined form a set of executable instructions that implement one or multiple functions that may together form a program such as that described herein.

In another example, the machine readable instructions may be stored in a state in which the instructions may be read by processor circuitry, but use a library (e.g., a dynamic link library (DLL)), a software development kit (SDK), an application programming interface (API), etc. in order to execute the instructions on a particular computing device or other device. In another example, the machine readable instructions are to be configured (e.g., settings stored, data input, network addresses recorded, etc.) before the machine readable instructions, the corresponding program(s), or combination thereof can be executed in whole or in part. Thus, machine readable media, as used herein, may include machine readable instructions, program(s), or combination thereof regardless of the particular format or state of the machine readable instructions, program(s), or combination thereof when stored or otherwise at rest or in transit.

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

The example process of FIG. 4 may be implemented using executable instructions (e.g., computer readable instruction or machine readable instructions) stored on a non-transitory computer, machine readable medium, or combination thereof such as a hard disk drive, a flash memory, a read-only memory, a compact disk, a digital versatile disk, a cache, a random-access memory, any other storage device or storage disk, or combination thereof in which information is stored for any duration (e.g., for extended time periods, permanently, for brief instances, for temporarily buffering, for caching of the information, or combination thereof). As used herein, the term non-transitory computer readable medium is expressly defined to include any type of computer readable storage device, storage disk, or combination thereof and to exclude propagating signals, to execute transitory propagating signals, and to exclude transmission media.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc. may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, and (7) A with B and with C. As used herein in the context of describing structures, components, items, objects, and/or things, the phrase “at least one of A and B” or “at least A or B, or a combination thereof” is intended to refer to implementations including any of (1) at least one A, (2) at least one B, and (3) at least one A and at least one B. Similarly, as used herein in the context of describing structures, components, items, objects, things, or combination thereof the phrase “at least one of A or B” or “at least A or B, or a combination thereof” is intended to refer to implementations including any of (1) at least one A, (2) at least one B, and (3) at least one A and at least one B. As used herein in the context of describing the performance or execution of processes, instructions, actions, activities, steps, or combination thereof, the phrase “at least one of A and B” or “at least A or B, or a combination thereof” is intended to refer to implementations including any of (1) at least one A, (2) at least one B, and (3) at least one A and at least one B. Similarly, as used herein in the context of describing the performance or execution of processes, instructions, actions, activities, steps, or combination thereof, the phrase “at least one of A or B” or “at least A or B, or a combination thereof” is intended to refer to implementations including any of (1) at least one A, (2) at least one B, and (3) at least one A and at least one B.

As used herein, singular references (e.g., “a”, “an”, “first”, “second”, etc.) do not exclude a plurality. The term “a” or “an” entity, as used herein, refers to one or multiple ones of that entity. The terms “a” (or “an”), “one or multiples ones of,” “one or more”, and “at least one” can be used interchangeably herein. Furthermore, although individually listed, a plurality of means, elements or method actions may be implemented by, e.g., a single unit or processor. Additionally, although individual features may be included in different examples or claims, these may possibly be combined, and the inclusion in different examples or claims does not imply that a combination of features is not feasible or advantageous.

FIG. 4 is an example flowchart 400 representative of example machine readable instructions that may be executed by the example resistance controller IC 228 of FIG. 3 to determine the resistance(s) for the example variable resistors 220, 222, 224. Although the flowchart 400 of FIG. 4 is described in conjunction with the example circuit 200 of FIG. 2, the flowchart 400 may be described in conjunction with any type of computing system that includes battery cells.

At block 402, the example interface 300 obtains cell voltage 210, 214, 218, the cell internal resistance 208, 212, 216, or combination thereof from the example gas gauge 226. As disclosed herein, the gas gauge 226 can measure or infer different information (e.g., temperature, voltage, internal resistance, capacitance, etc. corresponding to the individual battery cells) that is provided to the example interface 300. In some examples, prior to obtaining the internal resistance 208, 212, 216, the example sensor 312 sense the output voltage Vj and the example interface 300 transmits the sensed output voltage to the example gas gauge 226. In this manner, the gas gauge 226 can use the output voltage to determine the internal resistances 208, 212, 216. If the resistance controller IC 228 balances or rebalances the example battery cells 202, 204, 206 when the battery cells 202, 204, 206 are fully charged, the example interface 300 may only obtain the cell internal resistances 208, 212, 216 from the example gas gauge 226. At block 404, the example comparator 308 determines if the cells have previously been balanced. The comparator 308 determines if the cells have been previously balanced when previous information corresponding to one of the battery cells 202, 204, 206 or multiple ones of the battery cells 202, 204, 206 is stored in the example storage 310. If the cells were previously balanced, the comparator 308 can determine that amount of change between the current obtained information and previously obtained information to determine whether the rebalancing frequency should be adjusted based on the comparison of the battery cell information to previous battery cell information.

If the example comparator 308 determines that the cells were not previously balanced (block 404: NO), control continues to block 410. If the example comparator 308 determines that the cells were previously balanced (block 404: YES), the example comparator 308 compares the obtained cell voltages, cell internal resistances, or combination thereof to previous cell voltages, previous cell internal resistances, or combination thereof from the example storage 310 (block 406). For example, the comparator 308 may compare the amount of change of the voltage, internal resistance, or combination thereof of one of the battery cells 202, 204, 206 or of multiple ones of the battery cells 202, 204, 206 to a threshold or to multiple thresholds.

At block 408, the example timer 306 adjusts the rebalancing frequency based on the amount of change (e.g., to increase the rebalancing frequency when the amount of change is large decrease the rebalancing frequency when the amount of change is low). At block 410, the example resistance determination circuit 302 calculates the desired variable resistances for the battery cells 202, 204, 206 based on the obtained voltages, internal resistances, desired outcome (e.g., power distribution, time of discharge, time of charge, etc.), or combination thereof. If the resistance controller IC 228 balances or rebalances the example battery cells 202, 204, 206 when the battery cells 202, 204, 206 are fully charged, the example resistance determination circuit 302 calculate the desired variable resistance for the battery cells 202, 204, 206 using the cell internal resistances 208, 212, 216. In some examples, the resistance determination circuit 302 may utilize additional information, alternative information, or combination thereof to determine the desired variable resistances. In some examples, the resistance determination circuit 302 may determine the desired variable resistances for the respective battery cells 202, 204, 206 using a AI-based model, as disclosed herein.

At block 412, the example drivers 304 output signals to the respective example variable resistors 220, 222, 224 corresponding to the calculated desired resistances. In this manner, the variable resistors 220, 222, 224 adjust the current/power being drawn out from or into the example respective battery cells 202, 204, 206 to ensure the desired outcome. At block 414, the example timer 306 determines if it is time to rebalance the cells based on the current rebalancing frequency. In some examples, after the timer 306 determines it is time to rebalance the battery cells 202, 204, 206, the resistance controller IC 228 waits until the battery cells 202, 204, 206 are fully charged (e.g., so that the voltages of the battery cells 202, 204, 206 are the same) to simplify the rebalancing protocol based on the internal resistances 208, 212, 216. In such examples, the gas gauge 226 may transmit a trigger when the battery cells 202, 202, 204 are fully charged. In some examples, the gas gauge 226 may trigger (e.g., instruction, interrupt, etc.) rebalance outside of the rebalancing frequency based on observations from determined or sensed data. For example, if the gas gauge 226 determines that a measured power distribution does not match a desired power distribution, the gas gauge 226 may instruct (e.g., via a trigger or interrupt) the resistance controller IC 228 to perform rebalancing.

If the example timer 306 determines that it is not time to rebalance the battery cells 202, 204, 206 (block 414), control returns to block 414 until it is time to rebalance the battery cells. If the example timer 306 determines that it is time to rebalance the battery cells 202, 204, 206 (block 414: YES), control returns block 402 to obtain updated cell voltages and cell internal resistances from the gas gauge 226 for a rebalancing event.

FIG. 5 is a block diagram of an example processor platform 500 structured to execute the instructions of FIG. 4 to implement the resistance controller IC 228 of FIG. 3. The processor platform 500 can be, for example, a server, a computer, a self-learning machine (e.g., a neural network), an Internet appliance, or any other type of computing device.

The processor platform 500 of the illustrated example includes a processor 512. The processor 512 of the illustrated example is hardware. For example, the processor 512 can be implemented by integrated circuit(s), logic circuit(s), microprocessor(s), GPU(s), DSP(s), controller(s), or combination thereof from any desired family or manufacturer. The hardware processor may be a semiconductor based (e.g., silicon based) device. In this example, the processor implements the example interface 300, the example resistance determination circuit 302, the example drivers 304, the example timer 306, and the example comparator 308.

The processor 512 of the illustrated example includes a local memory 513 (e.g., a cache). In the example of FIG. 5, the local memory 513 implements the example storage 310. The processor 512 of the illustrated example is in communication with a main memory including a volatile memory 514 and a non-volatile memory 516 via a bus 518. The volatile memory 514 may be implemented by Synchronous Dynamic Random Access Memory (SDRAM), Dynamic Random Access Memory (DRAM), RAMBUS® Dynamic Random Access Memory (RDRAM®), any other type of random access memory device, or combination thereof. The non-volatile memory 516 may be implemented by flash memory, any other desired type of memory device, or combination thereof. Access to the main memory 514, 516 is controlled by a memory controller.

The processor platform 500 of the illustrated example also includes an interface circuit 520. The interface circuit 520 may be implemented by any type of interface standard, such as an Ethernet interface, a universal serial bus (USB), a Bluetooth® interface, a near field communication (NFC) interface, a PCI express interface, or combination thereof.

In the illustrated example, input device(s) 522 are connected to the interface circuit 520. The input device(s) 522 permit(s) a user to enter data, commands, or combination thereof into the processor 512. The input device(s) can be implemented by, for example, an audio sensor, a microphone, a camera (still or video), a button, a mouse, a touchscreen, etc.

Output device(s) 524 are also connected to the interface circuit 520 of the illustrated example. The output device(s) 524 can be implemented, for example, by display devices (e.g., a light emitting diode (LED), an organic light emitting diode (OLED), a liquid crystal display (LCD), a cathode ray tube display (CRT), an in-place switching (IPS) display, a touchscreen, etc.), a tactile output device, speaker, or combination thereof. The interface circuit 520 of the illustrated example, thus, typically includes a graphics driver card, a graphics driver chip, a graphics driver processor, or combination thereof.

The interface circuit 520 of the illustrated example also includes a communication device such as a transmitter, a receiver, a transceiver, a modem, a residential gateway, a wireless access point, a network interface, or combination thereof to facilitate exchange of data with external machines (e.g., computing devices of any kind) via a network 526. The communication can be via, for example, an Ethernet connection, a digital subscriber line (DSL) connection, a telephone line connection, a coaxial cable system, a satellite system, a line-of-site wireless system, a cellular telephone system, etc.

The processor platform 500 of the illustrated example also includes one or multiple mass storage devices 528 for storing software, data, or combination thereof. Examples of such mass storage devices 528 include floppy disk drives, hard drive disks, compact disk drives, Blu-ray disk drives, redundant array of independent disks (RAID) systems, and digital versatile disk (DVD) drives.

The machine executable instructions 532 of FIG. 4 may be stored in the mass storage device 528, in the volatile memory 514, in the non-volatile memory 516, on a removable non-transitory computer readable storage medium such as a CD or DVD, or combination thereof.

Example methods, apparatus, and articles of manufacture disclosed herein provide battery cell rebalancing. For example, examples disclosed herein couple a variable resistor to the output of a battery cell to reduce the current, power, or combination thereof being drawn from or to the battery cell. In this manner, examples disclosed herein can power a computing device with asymmetrical battery cells (or symmetrical battery cells) while ensuring that the power distribution is balanced. In this manner, the asymmetrical battery cells can individually operate according to their respective ratings and avoid damage, premature degradation, or combination thereof. Accordingly, examples disclosed herein provide more battery capacitance based on the space available for battery cells without the risk associated to unbalanced asymmetrical battery cells.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

What is claimed is:

1. An apparatus comprising:
a first battery cell having a first size;
a second battery cell having a second size different than the first size;
a first variable resistor couplable to the first battery cell;
a second variable resistor couplable to the second battery cell;
a sensor to determine a first internal resistance of the first battery cell, and a second internal resistance of the second battery cell; and
an integrated circuit to adjust a first resistance of the first variable resistor and a second resistance of the second variable resistor based on the first internal resistance and the second internal resistance.

2. The apparatus of claim 1, wherein the integrated circuit is to adjust the first resistance and the second resistance to limit a first power being drawn from the first battery cell to a first power rating and to limit a second power from being drawn from the second battery cell to a second power rating.

3. The apparatus of claim 1, wherein the integrated circuit is to adjust the first resistance and the second resistance based on a charging time or a discharging time of the first battery cell, the second battery cell, or a combination thereof.

4. The apparatus of claim 1, further including storage to store a third internal resistance of the first battery cell and a fourth internal resistance of the second battery cell, the third internal resistance and the fourth internal resistance determined prior to the first internal resistance and the second internal resistance.

5. The apparatus of claim 4, wherein the integrated circuit is to:
compare the first internal resistance to the third internal resistance, the second internal resistance to the fourth internal resistance, or a combination thereof; and
adjust a rebalancing frequency based on the comparison.

6. The apparatus of claim 5, wherein the integrated circuit is to rebalance the first variable resistor and the second variable resistor at a time corresponding to the rebalancing frequency.

7. A non-transitory computer readable medium comprising instruction which, when executed, cause at least one processor to:
calculate a first resistance for a first variable resistor and a second resistance for a second variable resistor based on a first internal resistance of a first battery cell and a second internal resistance of a second battery cell, the first battery cell having a size different than the second battery cell;
adjust the first variable resistor to the first resistance; and
adjust the second variable resistor to the second resistance.

8. The computer readable medium of claim 7, wherein the instruction cause the at least one processor to determine the first resistance and the second resistance to limit a first power being drawn from the first battery cell to a first power rating and to limit a second power from being drawn from the second battery cell to a second power rating.

9. The computer readable medium of claim 7, wherein the instruction cause the at least one processor to determine the first resistance and the second resistance based on a charging time or a discharging time of the first battery cell, the second battery cell, or a combination thereof.

10. The computer readable medium of claim 7, wherein the instruction cause the at least one processor to store a third internal resistance of the first battery cell, and a fourth internal resistance of the second battery cell, the third internal resistance and the fourth internal resistance, determined prior to the first internal resistance and the second internal resistance.

11. The computer readable medium of claim 10, wherein the instruction cause the at least one processor to:
compare the first internal resistance to the third internal resistance, the second internal resistance to the fourth internal resistance, or a combination thereof; and
adjust a rebalancing frequency based on the comparison.

12. The computer readable medium of claim 11, wherein the instruction cause the at least one processor to rebalance the first variable resistor and the second variable resistor at a time corresponding to the rebalancing frequency.

13. An apparatus comprising:
a first battery cell;
a first variable resistor coupled to the first battery cell;
a second battery cell;
a second variable resistor coupled to the second battery cell; and
a circuit to balance power to be drawn from the first battery cell and the second battery cell based on a first internal resistance of the first battery cell and a second internal resistance of the second battery cell by adjusting the first variable resistor to a first resistance and adjusting the second variable resistor to a second resistance.

14. The apparatus of claim 13, wherein the circuit is to determine the first resistance and the second resistance to limit a first power to be drawn from the first battery cell to a first power rating and to limit a second power from to be drawn from the second battery cell to a second power rating.

15. The apparatus of claim 13, wherein the circuit is to determine a third resistance for the first variable resistor, a fourth resistance for the second variable resistor, or a combination thereof based on a change in the first internal resistance of the first battery cell, the second internal resistance of the second battery cell, or a combination thereof.
